(19) United States
(12) Patent Application Publication
(10) Pub. No.: US 2023/0081628 A1
(43) Pub. Date: Mar. 16, 2023

(54) Capillary electrolysis in alkaline solution

(71) Applicants: Khamma Phengsavath, Boisbriand (CA); Daniel Duchemin, St-Boniface (CA)

(72) Inventors: Khamma Phengsavath, Boisbriand (CA); Daniel Duchemin, St-Boniface (CA)

(21) Appl. No.: 17/943,653

(22) Filed: Sep. 13, 2022

(30) Foreign Application Priority Data
Sep. 13, 2021 (GB) 2113056.2

(51) Int. Cl. C25B 1/04; C25B 9/17; C25B 11/052; C25B 11/061; C25B 11/075; C25B 9/67

(52) U.S. Cl. CPC C25B 1/04; C25B 9/17; C25B 11/052; C25B 11/061; C25B 11/075; C25B 9/67

(57) ABSTRACT

A capillary electrolysis in alkaline solution to produce hydrogen has a container having a plurality of polarized electrodes immersed in a chemical solution. A power source to generate the required electricity to produce a chemical reaction between the chemical solution and the electrodes.

### CROSS-REFERENCE TO RELATED APPLICATIONS

The present application claims priority to request for grant of a patent number 2113056.2, filed on Sep. 13, 2021, the disclosure of which is hereby incorporated in its entirety at least by reference.

### BACKGROUND OF THE INVENTION

### 1. Field of the Invention

The present invention relates generally to chemical processes but more particularly to a capillary electrolysis in alkaline solution.

### 2. Description of Related Art

Hydrogen is a clean burning fuel which could help mitigate the effects of climate change. Hydrogen can be used in fuel cells for electric vehicle as well as a fuel for internal combustion engines. The problem is that sometimes, fossil fuel is used for producing hydrogen, either by extracting it for the fuel or for generating the electricity required for electrolysis. This results in hydrogen having a substantial carbon footprint which makes its use as a fossil fuel replacement rather moot. There has to be a way to produce hydrogen with a small carbon footprint.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a hydrogen producing device.

In order to do so, the present invention provides for a capillary electrolysis in alkaline solution to produce hydrogen has a container having a plurality of polarized electrodes immersed in a chemical solution. A power source to generate the required electricity to produce a chemical reaction between the chemical solution and the electrodes.

The chemical solution is taken from the group comprising but not limited to sodium carbonate, potassium carbonate, potassium hydroxide, or sodium hydroxide.

The electrodes are made out of nickel plated stainless steel.

A flashback arrestor prevents the propagation of potential flames generated by the hydrogen gas.

A check valve prevents the regression of the gas back into the container.

A fan is used for cooling the container so that it does not overheat. Alternatively, a water cooled radiator system is used for cooling the container so that it does not overheat.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 See through schematic view of the invention.

FIG. 2 See through schematic view of the invention with a liquid cooling radiator.

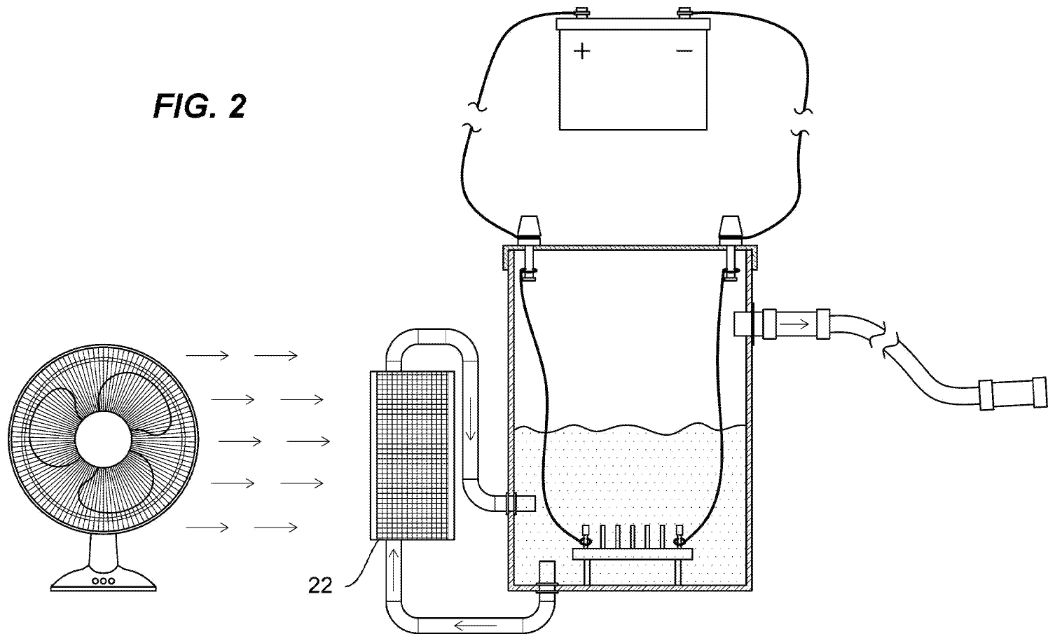

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

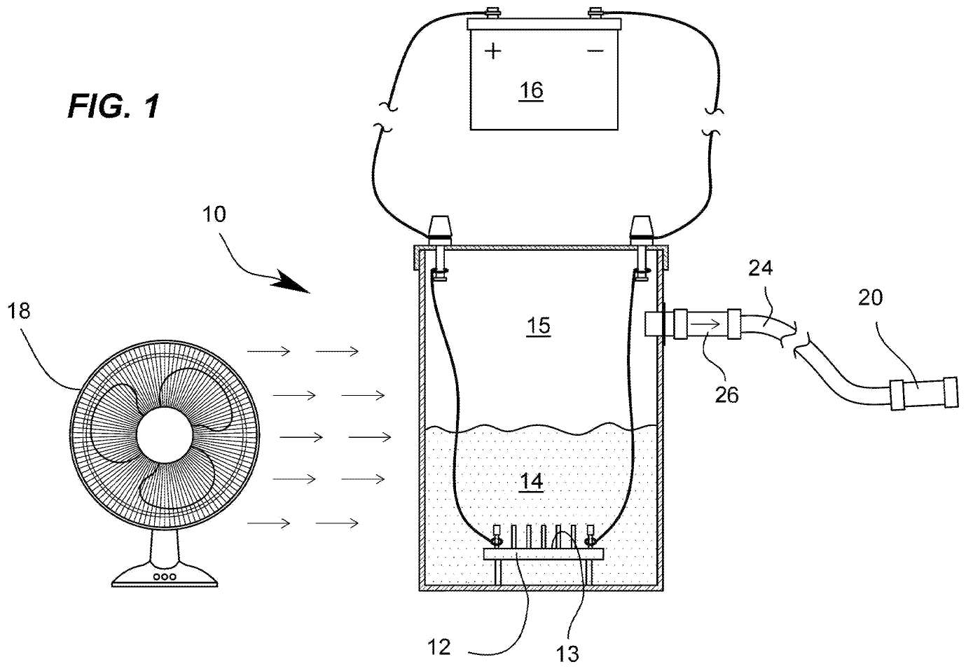

Referring now to any of the accompanying FIG. 1, according to a first embodiment, there is provided a capillary electrolysis in alkaline solution device for producing hydrogen which is comprised of a closed container (10) having a plurality of polarized electrodes (12) immersed in a chemical solution (14). The electrodes (12) are preferably nickel plated stainless steel and placed in a row at the bottom of the container. (10).

The plurality of electrodes (12) are spaced closely together by way of non-conducting spacers (13) which places the electrodes (12) generally spaced apart at a distance ranging from 1 mm to 10 mm so as to cause a capillary action as the solution is displaced by the current running in the electrodes (12).

A power source (16) which can be any form of power such as a battery or an AC powered DC power supply can supply the necessary electrical current to effect a chemical reaction from the electrodes acting on the chemical solution (14). Anywhere from 12 to 24 volts is sufficient to cause the chemical reaction. The chemical reaction causes hydrogen atoms to separate from the other atoms making up the aqueous chemical solution such as the following chemical compounds in solution: sodium carbonate (Na2CO3), potassium carbonate (K2CO3), potassium hydroxide (KOH), or sodium hydroxide (NaOH).

Hydrogen gas (15) thus being liberated moves to the top of the closed container 10, and from there, it goes though a pipe (24) and to where it will be collected, such as a pressure tank (not shown) for example.

Over time, the nickel wears off on the electrodes (12) and as the chemistry change, the chemical get out of solution and create a precipitate at the bottom of the container (10), so a periodic electrode (12) replacement and cleaning of the container (10) is advised.

A flashback arrestor (20) prevents the propagation of potential flames generated by the hydrogen gas (15).

A fan (18), or better still, a water cooled radiator system (22) is used to keep the device cool as the chemical reaction is exothermic.

Hydrogen, of course, has many uses, one of which being for use as a potential fuel to replace gasoline in cars. There is therefore a need for a way to produce hydrogen as cheaply as possible.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. A capillary electrolysis in alkaline solution to produce hydrogen comprising a container having a plurality of polarized electrodes immersed in a chemical solution; a power source to generate the required electricity to produce a chemical reaction between the chemical solution and the electrodes.

2. The capillary electrolysis of claim 1 wherein the chemical solution is taken from the group comprising but not limited to sodium carbonate, potassium carbonate, potassium hydroxide, or sodium hydroxide.

3. The capillary electrolysis of claim 1 wherein the electrodes are made out of nickel plated stainless steel.

4. The capillary electrolysis of claim 1 wherein flashback arrestor prevents the propagation of potential flames generated by the hydrogen gas.

5. The capillary electrolysis of claim 1 wherein a check valve prevents the regression of the gas back into the container.

6. The capillary electrolysis of claim 1 wherein a fan is used for cooling the container so that it does not overheat.

7. The capillary electrolysis of claim 1 wherein a water cooled radiator system is used for cooling the container so that it does not overheat.
